(19) United States
(12) Patent Application Publication
(10) Pub. No.: US 2002/0157499 A1
(43) Pub. Date: Oct. 31, 2002

(54) Stem of a bicycle having an iron member

(75) Inventor: Jim Liao, Hsin Chu Hsien (TW)

Correspondence Address: DOUGHERTY & TROXELL, 5205 LEESBURG PIKE, SUITE 1404, FALLS CHURCH, VA, 22041, US

(73) Assignee: Hsin Lung Accessories Co., Ltd.

(21) Appl. No.: 09/842,126

(22) Filed: Apr. 26, 2001

(51) Int. Cl. B62K 21/18

(52) U.S. Cl. 74/551.1

(57) ABSTRACT

A stem of a bicycle having an iron member, said stem being made of aluminum and adapted to be fixedly secured to a fork and to clamp a handlebar, comprises a block including a sleeve provided at one end thereof for insertion of the fork of a bicycle and a base provided at the other end thereof, said base defining a semicircular surface; a cover having a semicircular surface which, together with the semicircular surface of the base close around and clamp the handlebar when the cover is secured to the base; and at least one iron member having a semicircular configuration and an inner surfaces and an outer surface, the outer surface being disposed on at least one of the two semicircular surfaces so that the iron member rather than the two semicircular surfaces contacts the handlebar whereby scraping of the at least one of the two semicircular surfaces by the handlebar is prevented.

### BACKGROUND OF THE INVENTION

1. Field of the Invention

The present invention relates to a bicycle stem, more particularly, to a stem of a bicycle the surface of which is prevented being worn away by scraping of a handlebar when clamped thereon.

2. Description of the Related Art

As shown in FIGS. 1 and 2, a handlebar 2 is clamped between the semicircular surface 104 and the semicircular surface 105 of conventional stem 1, the stem 1 is often utilized in performance activity and is made from aluminum material rather than iron material since a stem made of aluminum material is light weight and can be easily controlled in a bouncing up and down. However, the aluminum material is of soft characteristic and is easily scrape by the teeth region 4 of the handlebar 2 made from an iron material. The bumpy bouncing operation of the bicycle causes the handlebar 2 to bear a relatively large force, such that the plurality of teeth in the teeth region 4 scrape surfaces 104,105 of the stem 1 which clamp the handlebar 2. In the long run, said two surfaces 104,105 cannot tightly clamp the handlebar 2 and might loosen the handlebar 2 during use. This leads to a potential risk for user in performance.

### SUMMARY OF THE INVENTION

Accordingly, an object of the present invention is to provide a stem of a bicycle the surface of which is prevented from being worn away by the handlebar clamped thereby.

To achieve the object mentioned above, the present invention provides a stem of a bicycle having an iron member, said stem being made of aluminum and adapted to be fixedly secured to a fork and to clamp a handlebar, comprising:

a block including a sleeve provided at one end thereof for insertion of the fork of a bicycle and a base provided at the other end thereof, said base defining a semicircular surface;

a cover having a semicircular surface which, together with the semicircular surface of the base close around and clamp the handlebar when the cover is secured to the base; and

at least one iron member having a semicircular configuration and an inner surfaces and an outer surface, the outer surface being disposed on at least one of the two semicircular surfaces so that the iron member rather than the two semicircular surfaces contacts the handlebar whereby scraping of the at least one of the two semicircular surfaces by the handlebar is prevented.

### BRIEF DESCRIPTION OF THE DRAWING

The above objects and advantages of the present invention will become more apparent by the following detailed description of a preferred embodiment in conjunction with the accompanying drawings, in which:

FIG. 1 shows a perspective view of a conventional stem clamping a handlebar;

FIG. 2 shows an exploded view of the conventional stem clamping a handlebar;

FIG. 3 shows an exploded view of the stem of a bicycle having an iron member according to the present invention;

FIG. 4 shows a perspective view of the stem of the bicycle having an iron member according to the present invention in an assembled form;

FIG. 5 shows a perspective view of a second embodiment of the present invention;

FIG. 6 shows a sectional-cross view of the stem of the bicycle taken from line A-A shown in FIG. 5.

FIG. 7 shows an exploded view of a third embodiment according to the present invention;

FIG. 8 shows a perspective view of the third embodiment according to the present invention in an assembled form; and

FIG. 9 shows a perspective view of the fourth embodiment according to the present invention.

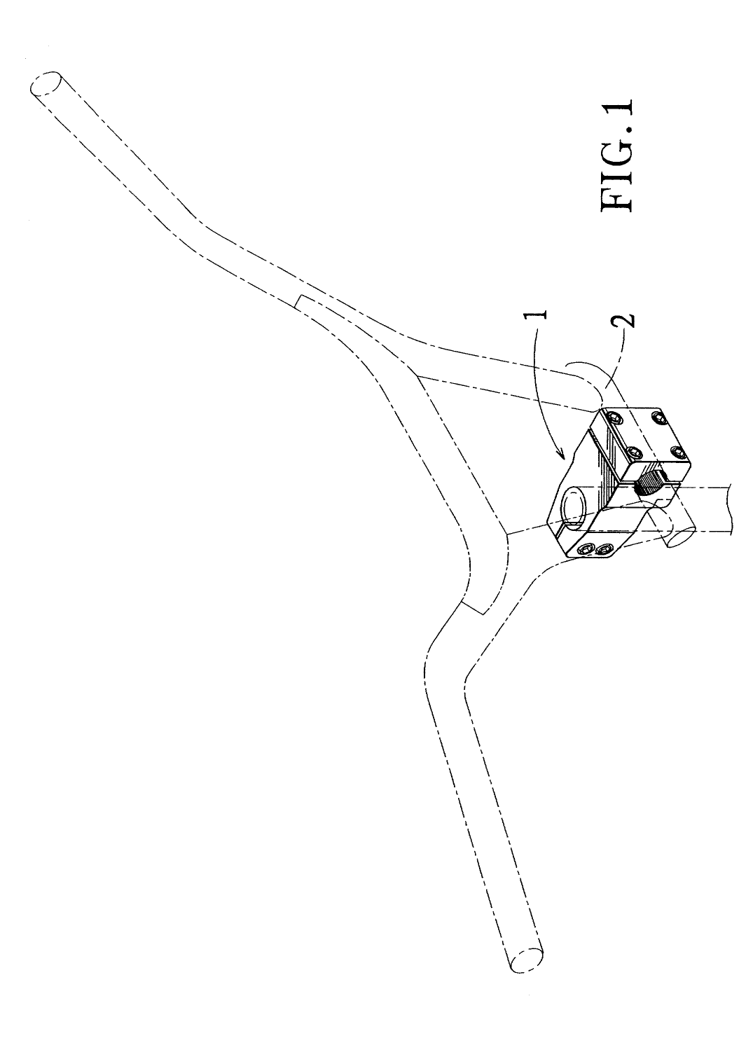

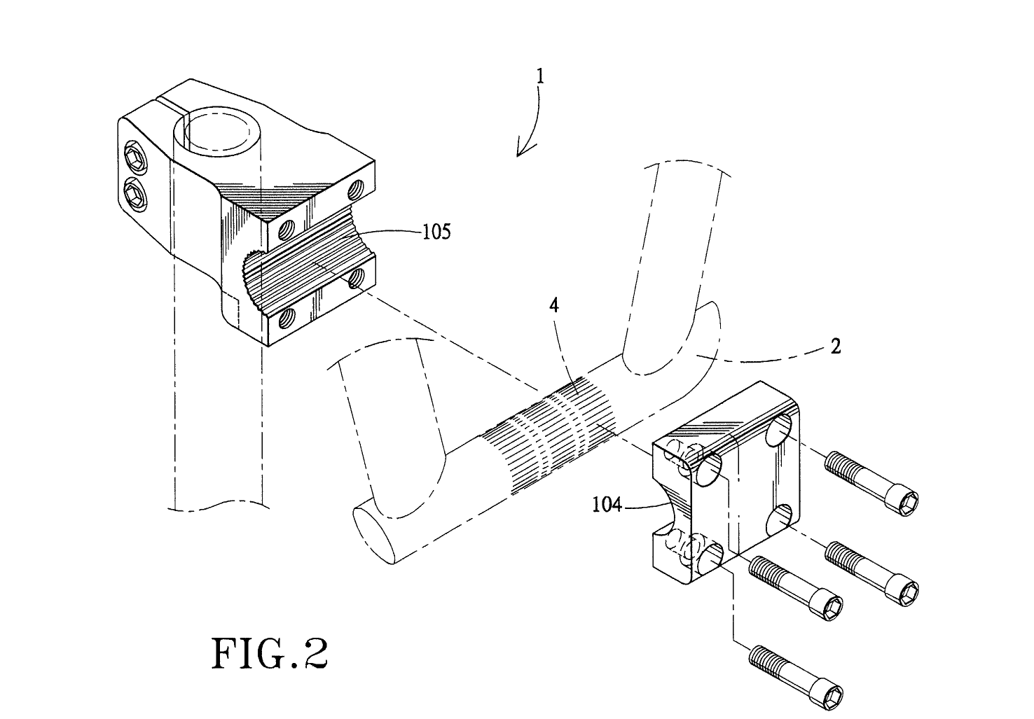

### DETAILER DESCRIPTION OF THE PREFERRED EMBODIMENT

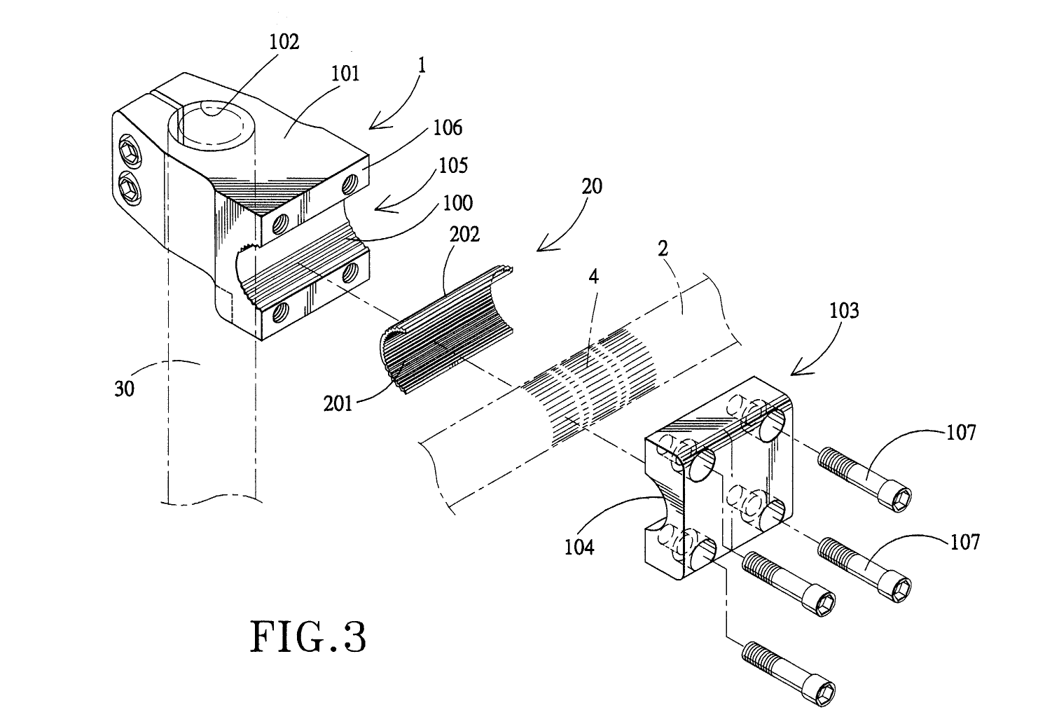

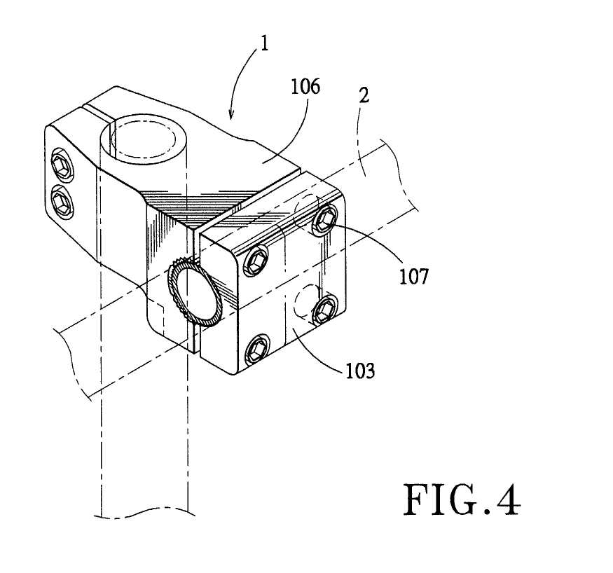

Referring now to FIGS. 3 and 4, the stem of a bicycle having an iron member according to the present invention is shown to comprise a conventional stem 1 and an iron member 20.

Said conventional stem 1 includes a block 101, a sleeve 102 provided at one end of the block 101 for insertion of a fork 30 of the bicycle, and a cover 103 having a semicircular surface 104. The other end of the block 101 is provided with a base 106 defining a semicircular surface 105 which is provided with a plurality of lateral teeth 100 thereon.

The cover 103 may be secured to the base 106 by screws 107 so that the two semicircular surfaces 104,105 together form a circular hole to clamp the handlebar 2.

Said iron member 20 is of a semicircular configuration and has an inner surface 201 and an outer surface 202. Each of the two surfaces 201,202 is provided with a plurality of lateral teeth. The iron member 20 is disposed on the semicircular surface 105 in such a manner that the teeth of the outer surface 202 engages with teeth 100 of the semicircular surface 105. The teeth region 4 of the handlebar 2 is fixedly clamped between the inner surface 201 of the iron member 20 and the semicircular surface 104 of the cover 103. The vibration of the handlebar 2 during performance of the bicycle will not render the contacting surface of the inner surface 201 and the teeth region 4 to be easily worn away since both the iron member 20 and the handlebar 2 are both made from iron material and we quite rigid.

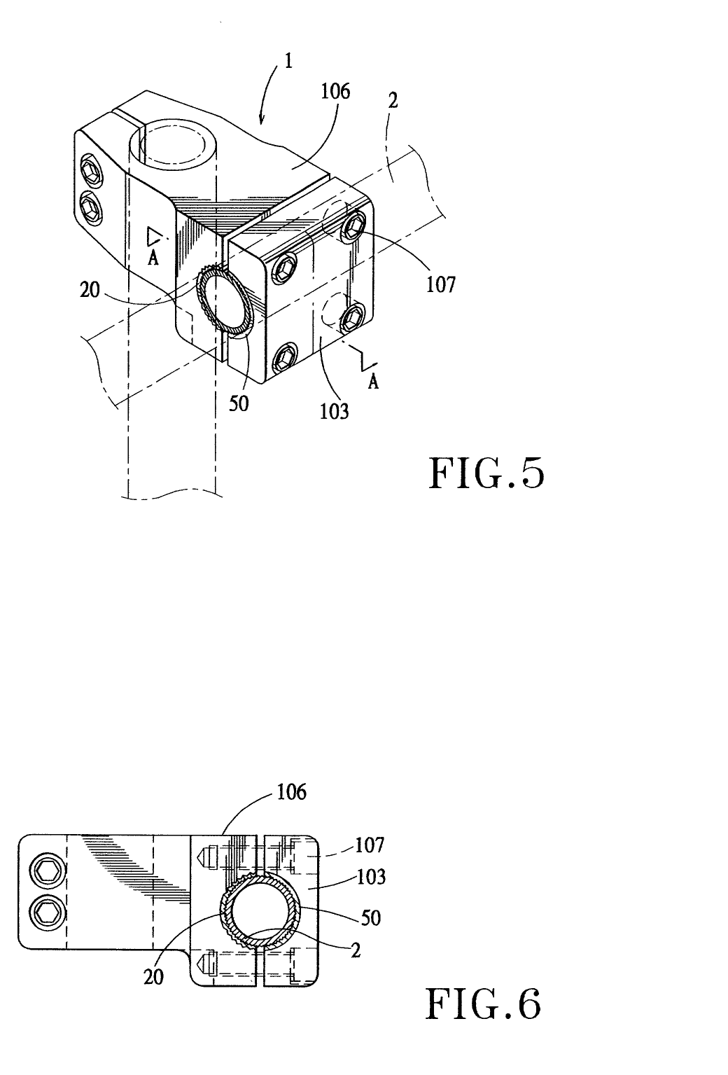

Referring to FIGS. 5 and 6, another piece of iron member 50 which is of the same construction and configuration as the iron member 20 may be arranged on the semicircular surface 104 of the cover 103 so as to further tightly clamp the handlebar 2 and protect the semicircular surface 104 from wear.

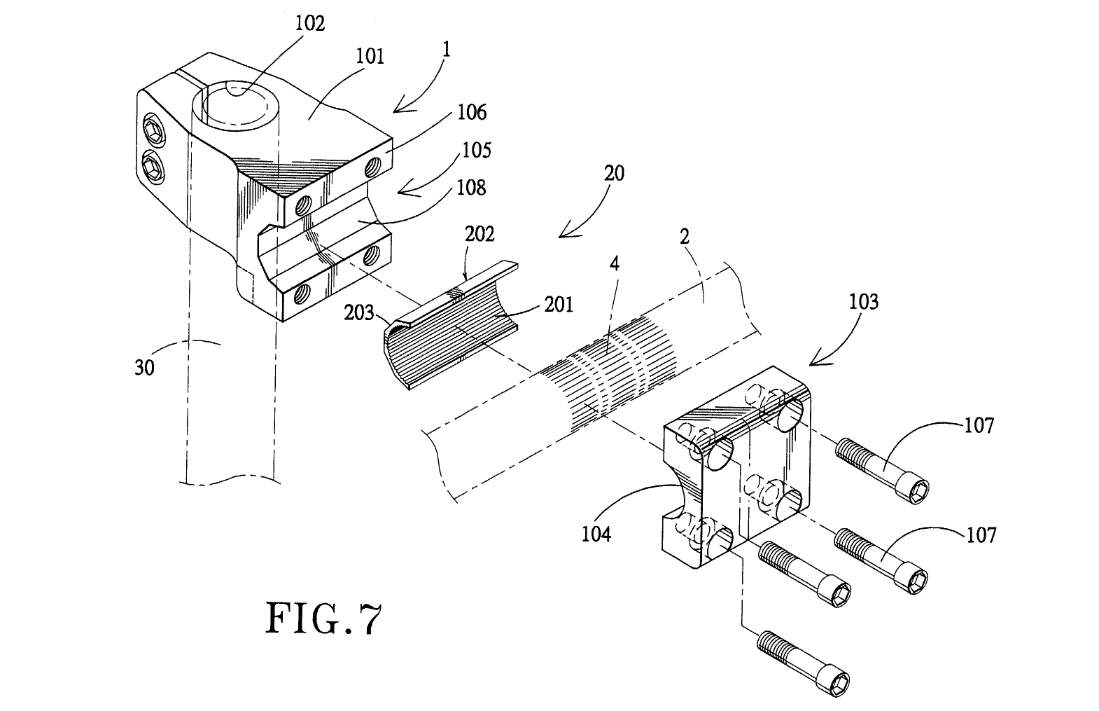

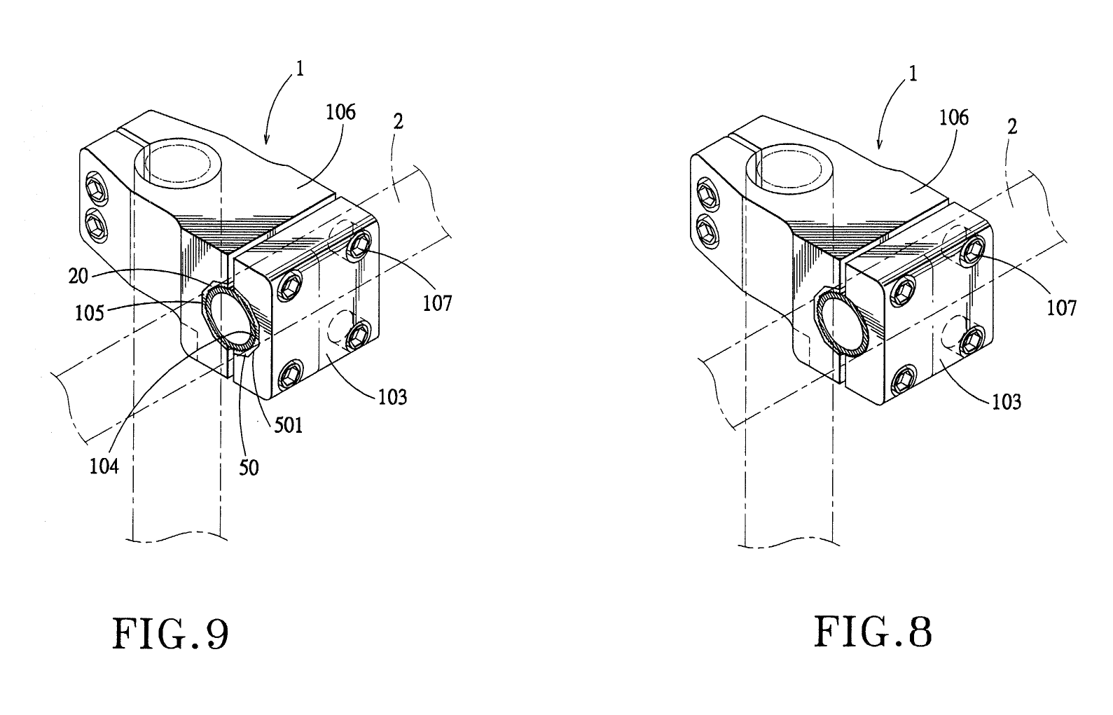

Referring to FIGS. 7 and 8 which show another embodiment according to the present invention, the semicircular surface 105 and the outer surface 202 of the iron member 20 are designed with a plurality of small slanted surfaces 108,203, respectively. The small slanted surface 108 corresponds to the small slanted surface 203 and thus, the slanted surface 203 cannot upwardly or downwardly move relative to the small slanted surface 108 when it is disposed on the small slanted surface 108. This will tightly clamp the handlebar 2 as well. Referring to FIG. 9, there is shown another iron member 50 having a plurality of small slanted surfaces 501 engagingly corresponding to a plurality of small slanted surfaces of the cover 103.

Therefore, the iron member may be disposed on the semicircular surface 104 or semicircular surface 105 only or both so as to prevent the two semicircular surfaces from contacting the teeth region 4 of the handlebar and being scraped thereby.

While there is shown and described herein certain specific structures embodying the present invention, it will be apparent to those skilled in the art that various modification and rearrangements of the parts may be made without departing from the spirit and scope of the underlying inventive concept.

1. A stem of a bicycle having an iron member, said stem being made of aluminum and adapted to be fixedly secured to a fork and to clamp a handlebar, comprising:
a block including a sleeve provided at one end thereof for insertion of the fork of a bicycle and a base provided at the other end thereof, said base defining a semicircular surface;
a cover having a semicircular surface which, together with the semicircular surface of the base close around and clamp the handlebar when the cover is secured to the base; and
at least one iron member having a semicircular configuration and an inner surfaces and an outer surface, the outer surface being disposed on at least one of the two semicircular surfaces so that the iron member rather than the two semicircular surfaces contacts the handlebar whereby scraping of the at least one of the two semicircular surfaces by the handlebar is prevented.

2. A stem of a bicycle as claimed in claim 1, wherein each of the inner and outer surfaces of the iron member is provided with a plurality of lateral teeth.

3. A stem of a bicycle as claimed in claim 1, wherein the outer surface of the iron member is provided with a plurality of small slanted surface.
